(19) United States
(12) Patent Application Publication
(10) Pub. No.: US 2025/0041813 A1
(43) Pub. Date: Feb. 6, 2025

(54) PLANTING SYSTEM HAVING AGITATOR

(71) Applicant: DENDRA SYSTEMS LTD., Oxford (GB)

(72) Inventors: Ashwinsekar Chandrasekaran, Newcastle (AU); Alec Lewandowski, Valentine (AU); Brian Hornsby, Hammond Park (AU)

(21) Appl. No.: 18/230,121

(22) Filed: Aug. 3, 2023

(51) Int. Cl. B01F 27/13; A01C 7/08; A01C 17/00; A01C 19/02; B01F 27/054; B01F 27/96; B01F 33/502; B64D 1/02

(52) U.S. Cl. CPC B01F 27/13; A01C 7/085; A01C 17/003; A01C 19/02; B01F 27/054; B01F 27/96; B01F 33/502; B64D 1/02; B64U 10/14; B64U 2101/40

(57) ABSTRACT

A planting system includes a seed spreading assembly mounted on an unmanned aerial vehicle (UAV). The seed spreading assembly includes a hopper having a hopper cavity, and an agitator. The agitator is coupled to the hopper, and includes an agitator frame in the hopper cavity. The agitator frame includes one or more agitator members coupled to a support subframe. The one or more agitator members are more flexible than the support subframe. Other embodiments are also described and claimed.

### BACKGROUND

### Field

The present disclosure relates to systems for dispensing particles. More specifically, the present disclosure relates to planting systems for dispensing seeds.

### Background Information

There are existing techniques for dispensing particles, such as fertilizer or seed, in both agricultural and non-agricultural endeavors. For example, crop planters exist that dispense agricultural seeds to produce crops. Such planters commonly have a seed container that holds the seeds prior to dispensing the seeds through a metering system. The crop planters may have one or more horizontal augers located within the seed container to agitate and transfer the seeds from the seed container to the metering system. The metering system can include a slot through which seeds exit the seed container to be spread onto the ground. Non-agricultural endeavors, such as reseeding to revegetate geographies that have been negatively impacted by influences such as fire, over-grazing, etc., can also utilize planting systems. The planting systems can spread non-agricultural seeds over the geography, rather than spread agricultural seeds within well-defined crop boundaries.

A morphology and anatomy of seeds can vary widely by seed type. Some agricultural seeds, such as millet, oat, or wheat, may have a seed coat texture that differs substantially from other agricultural or non-agricultural seeds. For example, the texture and anatomy of millet seeds may cause the seeds to be far less likely to bind together than, for example, some Australian grass seeds that have fibers or hairs extending from the seed coat. Thus, the conventional seed containers, augers, and metering systems developed for use with some seed types, such as millet, may interact differently with other seed types.

### SUMMARY

Conventional augers have been found to poorly agitate seed types having seed coats that include fibers or hairs. The texture of such seed types can cause them to bind together, and the constant rotational motion of the auger may fail to agitate the seeds sufficiently to cause the seeds to enter the metering system. More particularly, when certain seed types are held in a seed container and agitated by an auger, the seeds compress, bind together, and do not slide into the metering system located at a base of the seed container. Moreover, the seeds can become stuck within the metering system itself. Under such conditions, conventional planting systems fail to adequately control the dispensation of seeds, which may result in inconsistent or insufficient seeding of a target geography. The stuck seeds may also overload the metering system and cause system components, such as a motor, to fail mechanically.

A planting system is provided. The planting system can include a seed spreading assembly mounted on an unmanned aerial vehicle (UAV). The UAV can transport the seed spreading assembly over a target geography while the seed spreading assembly conveys or dispenses seed material over the target geography. The seed spreading assembly includes a hopper having a hopper cavity. An agitator is coupled to the hopper. The agitator includes an agitator frame in the hopper cavity. In an embodiment, the agitator frame includes one or more agitator members coupled to a support subframe. The one or more agitator members are more flexible than the support subframe. Accordingly, the agitator frame has a hybrid flexibility such that certain regions are relatively rigid and certain regions are relatively resilient. The hybrid flexibility can, when the agitator frame is rotated within seeds in the hopper, facilitate efficient seed dispersal without mechanically overloading the agitator.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a perspective view of a planting system, in accordance with an embodiment.

FIG. 2 is a block diagram of a planting system, in accordance with an embodiment.

FIG. 3 is a perspective view of a seed spreading assembly, in accordance with an embodiment.

FIG. 4 is a cross-sectional view of a seed spreading assembly having an agitator, in accordance with an embodiment.

FIG. 5 is a front view of an agitator frame, in accordance with an embodiment.

FIG. 6 is a side view of an agitator frame, in accordance with an embodiment.

FIG. 7 is a block diagram of a computer system, in accordance with an embodiment.

### DETAILED DESCRIPTION

Embodiments describe a planting system including a seed spreading assembly to convey seeds. The seed spreading assembly includes an agitator to break up and move seed material through a hopper to a dispenser, such as rollers and/or a spreader. Accordingly, the planting system can be used to spread seeds, such as native Australian grass seeds, over a target geography. Although the seed spreading assembly is mainly described below with respect to use in a planting system for conveying seeds, the seed spreading assembly may be incorporated in systems used to dispense other particulate matter. For example, the seed spreading assembly can convey and dispense fertilizer in a fertilizer spreader. Thus, reference to the seed spreading assembly and the planting system are not limiting, and the terms may be generalized as being a material spreading assembly and a spreading system having the same or similar structures as those described below.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

The use of relative terms throughout the description may denote a relative position or direction. For example, “upward” may indicate a first direction along a central or vertical axis of a seed spreading assembly. Similarly, “downward” may indicate a second direction opposite to the first direction. Such terms are provided to establish relative frames of reference, however, and are not intended to limit the use or orientation of a planting system or a seed spreading assembly to a specific configuration described in the various embodiments below.

In an aspect, a planting system has an agitator to break up and convey seeds. The planting system can spread the seeds over a target geography. For example, the target geography may be a rugged or inaccessible terrain, and the planting system may include an unmanned aerial vehicle (UAV) to carry a seed spreading assembly to dispense seeds over the target geography. The seed spreading assembly can include a hopper containing the seeds, and the agitator can move the seeds from the hopper to a dispenser, such as rollers or a spreader. The rollers and/or spreader can eject the seeds onto the target geography. In an embodiment, the agitator includes an agitator frame having flexible agitator members supported by a rigid subframe. The selectively resilient frame can rotate within the hopper, to scrape, scoop, and otherwise agitate the seeds. Accordingly, the seeds can disperse and flow smoothly through the hopper to the dispenser and outward to the target geography.

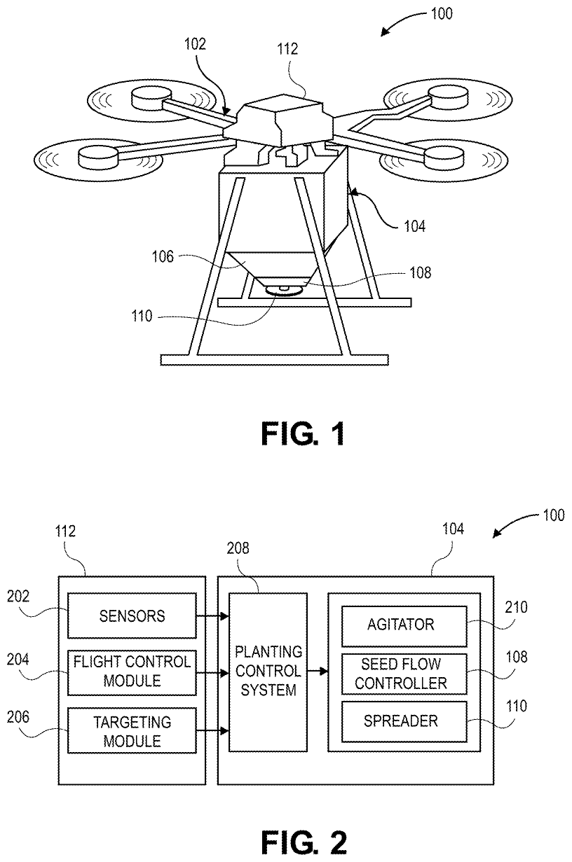

Referring to FIG. 1, a perspective view of a planting system is shown in accordance with an embodiment. The planting system 100 can include a mobile transport system to transport a seeding spreading assembly 104 over a target geography. The mobile transport system can be a ground-based system, such as a tractor, or an airborne system, such as an unmanned aerial vehicle (UAV) 102. The seed spreading assembly 104 can include a hopper 106 to contain seed material to spread over the target geography, and a seed flow controller 108 to pull and convey the seed material from the hopper 106 to a spreader 110. The spreader 110 can eject the seed material over the target geography. Accordingly, the seed spreading assembly 104 can be mounted on the UAV 102 and the UAV can carry the seed spreading assembly 104 to spread seeds over the ground as the UAV traverses a planting pattern.

In an embodiment, the UAV 102 is a MultiCopter-style or a quadcopter-style UAV or drone. The UAV 102, however, may be another type of UAV, such as a fixed wing drone, rotary-controlled drone, blimp, manually operated plane or helicopter, ultra-lite glider, or other aerial platform. Alternative copter-style drones include drones having a single blade, eight-blades, etc. In the case of a ground-based system, the seed spreading assembly 104 can be mounted on an automobile, bicycle, motorcycle, hand-pushed cart, an animal-drawn attachment, a land-based robotic system, or any other ground-based platform.

The seed spreading assembly 104 can contain a payload that is ready to be dispensed, spread, or planted. The payload can include any particulate that behaves, as a group, as a non-Newtonian fluid. For example, the payload may include agricultural seeds such as millet. Alternatively, the payload can include non-agricultural grass seeds, such as native Australian grass seed. The payload may include particulate that is non-biological. For example, the payload may include fertilizer to be spread over the target geography. In an embodiment, the payload is a mixture of agricultural grass seeds, non-agricultural grass seeds, and/or non-biological particulate. For example, the payload may include a mixture of Australian grass seeds and one or more tree or shrub seeds. At least some of the seed material can have wisps, spikes, jagged edges, etc., which tend to bind together.

The planting system 100 can include an electronics housing 112 containing electronics to control the operations of the UAV 102 and/or the seed spreading assembly 104 carried by the UAV. The electronics housing 112 may contain one or more processors that receive inputs from various sensors of the planting system 100. For example, the planting system 100 can include several onboard sensor devices that capture data relating to the position and orientation of the UAV 102. The one or more processors can process the sensor input data to determine outputs for controlling the planting system operation. By way of example, the one or more processors may provide an onboard navigation system that uses data from global positioning system (GPS) or other sensors mounted on the UAV 102 to determine a location of the planting system 100 in relation to the target geography. The planting system 100 can include control software, which when executed by the one or more processors, automates the activities of the aerial and/or land-based mobile transport platform to follow a planting pattern over the target geography.

The electronics module can contain wireless communication hardware, such as a Global System for Mobile Communications (GSM) module (modem to communicate and receive and transmit modes), to allow communication between the planting system 100 and a remote controller. For example, the communication hardware can connect wirelessly to a ground station or a mobile device. The ground station or the mobile device can be used by an operator to remotely control operation of the mobile transport system and/or the seed spreading assembly 104.

Referring to FIG. 2, a block diagram of a seed spreading assembly is shown in accordance with an embodiment. Sensors and modules of the planting system 100 can be housed in the electronics housing 112. For example, the planting system 100 can include one or more sensors 202, a flight control module 204, and a targeting module 206. The sensors can include a GPS module, visual, multispectral, hyperspectral, RADAR, light imaging detection and ranging (LiDAR), and infrared sensors, and visual cameras which register where seeds are planted and record the surroundings of the planting process. In some embodiments, sensors may include communication modules such as receivers, transmitters, transceivers, etc. The flight control module 204 can include a communications module to obtain flight commands from an operator, other mobile transport platform, or other system. The targeting module 206 can include a communications module to obtain targeting commands from a user, other mobile transport platform, or another system.

The sensors and modules can output data to the seed spreading assembly 104. The targeting module 206 can automatically send a dispense seed command to a planting control system 208 based on location, e.g., when a current GPS location is within the predefined boundaries of the target geography. In an embodiment, once the planting system 100 is near a predefined location, a live display of the target geography as viewed from the planting system 100 is displayed to a user, enabling the user to manually send the dispense seed command.

The planting control system 208 can be in a same or different enclosure of the electronics housing 112 as the sensors 202 and/or modules 204, 206. The planting control system 208 can manage agitation, dispensation, and spreading of the seed material by the seed spreading assembly 104. As described below, the seed spreading assembly 104 can include an agitator 210 to mix and agitate the seed material within the hopper 106. The seed spreading assembly 104 can also include the seed flow controller 108 to convey the seed material from the hopper 106 to the spreader 110, and the spreader 110 to spread the seeds onto the ground below the mobile transport system. In an embodiment, the planting control system 208, which may include one or more processors executing agitation, conveyance, and/or spreading algorithms, can provide outputs to control the mechanical function of the agitator 210, the seed flow controller 108, and/or the spreader 110. By way of example, the planting control system 208 can control a rate of rotation of an agitator motor operably coupled to a frame of the agitator.

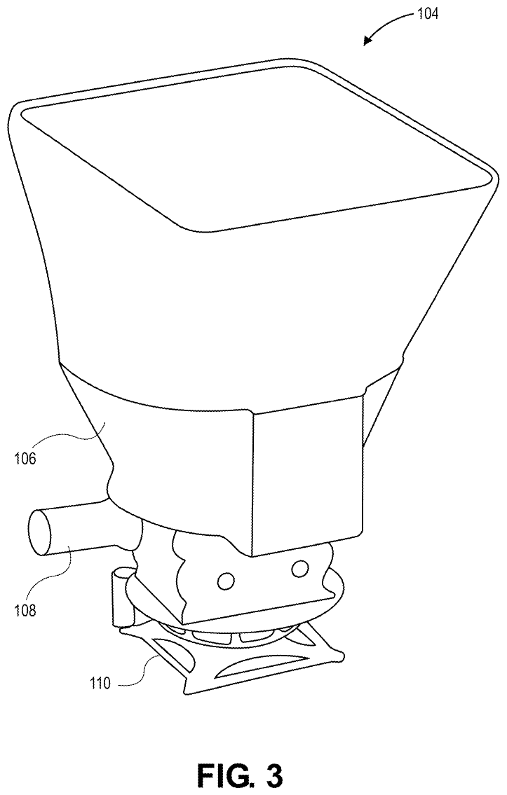

Referring to FIG. 3, a perspective view of a seed spreading assembly is shown in accordance with an embodiment. The seed spreading assembly 104 can be mounted on the UAV 102 as described above, and thus, the hopper 106, the seed flow controller 108, and the spreader 110 can be connected to the UAV 102. Furthermore, the seed spreading assembly components are connected to each other. More particularly, the hopper 106 is connected to the seed flow controller 108, and the seed flow controller 108 is connected to the spreader 110. As described below, the seed spreading assembly 104 overcomes the shortfalls of existing seed spreaders, which are unable to deal with clumping and binding of certain seed materials. More particularly, existing seed spreaders are unable to controllably spread problem materials in their raw (non-pre-processed) form. In the context of this description, a problem material may be defined as: a material having a fluffy, hook-and-loop, or cotton ball-like characteristic; a material that clamps or sticks together when in contact with itself, a material that sticks to other things when in contact; or a material that binds into bridges due to a material morphology. Problematic materials can bridge, jam, or otherwise block existing seed spreaders, causing unreliable operation and uncontrollable spreading of the problem materials. By contrast, the seed spreading assembly 104 includes an agitator that can break up clumps in problematic seed material, and feed the separated material from the hopper 106 to the seed flow controller 108 and spreader 110 at a controllable and predictable rate. As such, the seed spreading assembly 104 is able to spread the material consistently over the target geography. Furthermore, because the seed material is conveyed at a controllable rate, the spreader 110 can spread the material as far as possible with a reduced likelihood of damage to the seed material.

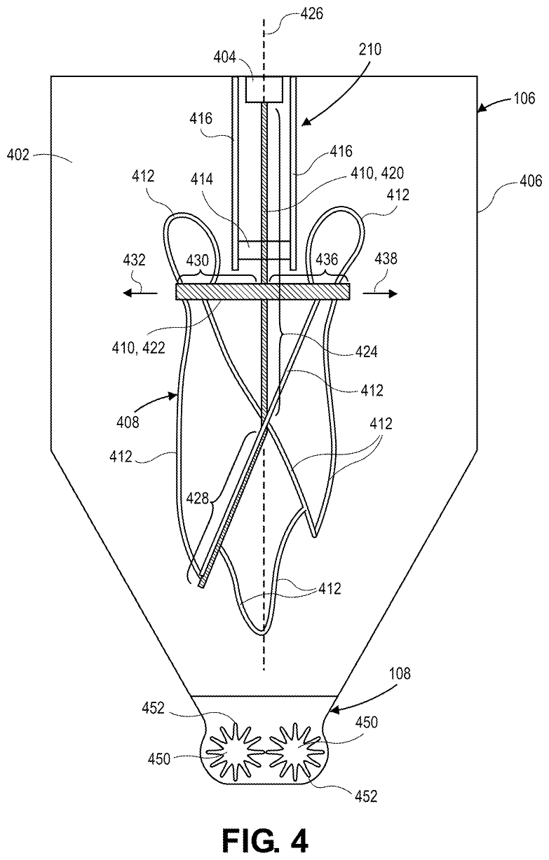

Referring to FIG. 4, a cross-sectional view of a seed spreading assembly is shown in accordance with an embodiment. An agitator 210 may optionally be coupled to the hopper 106. For example, the hopper 106 can have a hopper cavity 402, and the agitator 210 can be mounted within the hopper 106. The agitator 210 can provide mechanical disruption to disperse seed material stored in the hopper 106. The disruption can reduce a likelihood of bridging or stopping of material flow from the hopper cavity 402 to the seed flow controller 108 and/or spreader 110 (FIG. 3).

In an embodiment, the agitator 210 includes an agitator motor 404. The agitator motor 404 can mounted near a hopper inlet, e.g., at or above an upper rim of a hopper wall. More particularly, the agitator motor 404 can be mounted above the seed material in the hopper cavity 402. Such placement can avoid contact between the seed material and non-moving internal structures, e.g., the motor housing. Problematic seed materials can bridge and bind when exposed to non-moving parts, and thus, isolating the seed material from the non-moving parts can reduce a likelihood of stopping the seed flow.

The agitator motor 404 may connect to an agitator frame 408 of the agitator 210. For example, the agitator 210 can include an agitator frame 408 in the hopper cavity 402, and the agitator motor 404 can be operably coupled to the agitator frame 408. In an embodiment, the agitator frame 408 includes a support subframe 410 and one or more agitator members 412. The agitator members 412 can be connected to the support subframe 410. The support subframe 410 components are illustrated with cross-hatching to distinguish the components from the one or more agitator members 412, which are not illustrated with cross-hatching. The agitator motor 404 can be operably coupled to the support subframe 410 to drive rotation of the agitator frame 408 within the hopper cavity 402.

The support subframe 410 may be supported by a bearing 414 between a pair of vertical columns 416. The bearing 414 can bridge the pair of vertical columns 416, and surround a portion of the support subframe 410. More particularly, the bearing 414 can center and hold the agitator frame 408 such that, when the agitator motor 404 spins the support subframe 410, the bearing 414 stabilizes the support subframe 410 against lateral loading. Accordingly, the agitator frame 408 can sweep through the hopper cavity 402 to disperse seeds contained by the hopper 106. At least a portion of the agitator frame 408, e.g., the support subframe 410, can be rigid, and therefore the agitator 210 can break up seeds as the agitator frame 408 rotates within the hopper cavity 402.

The agitator frame 408 can have a hybrid flexibility. More particularly, at least one portion of the agitator frame 408 is more flexible than another portion of the agitator frame. In an embodiment, the one or more agitator members 412 are more flexible than the support subframe 410. The relative flexibility can be measured based on a deflection of the components when a reactive force from seeds within the hopper cavity 402 is applied to the frame surface. More particularly, when the agitator frame 408 rotates within the seeds, the seeds can resist the agitation force applied by the agitator frame 408. The support subframe 410, which is more rigid than the one or more agitator members 412, can bend and/or twist less than the agitator members 412 under the reactive loading applied by the agitated seeds. Accordingly, the agitator frame 408 can resiliently give way to the seeds in some areas, but robustly disrupt the seeds in other areas. The relative flexibilities of the frame components and their respective influence on seed disruption is described further below.

The rigid support subframe 410 can include several interconnected components. For example, the support subframe 410 can include a drive bar 420 and a crossbar 422 coupled to each other in a crossing pattern. The drive bar 420 can extend vertically within the hopper cavity 402. For example, an upper end of the drive bar 420 can connect to the agitator motor 404, and a drive segment 424 of the drive bar 420 can extend along the vertical axis 426 through the bearing 414 to a lower end of the drive segment 424. By contrast, the crossbar 422 can be coupled to the drive bar 420, and can extend horizontally within the hopper cavity 402. More particularly, whereas the drive segment 424 of the drive bar 420 can extend vertically within the hopper cavity 402, the crossbar 422 can extend horizontally within the hopper cavity 402.

In an embodiment, the agitator frame 408 can contact the hopper wall 406. For example, one or more of the agitator members 412 can touch the hopper wall 406 surrounding the hopper cavity 402. Accordingly, when the agitator frame 408 rotates within the hopper cavity 402, the one or more agitator members 412 can scrape the hopper wall 406. Seeds along the wall may therefore be agitated and moved within the hopper cavity 402 to facilitate dispersal.

The support subframe 410 components may be further segmented. In an embodiment, the drive bar 420 includes a mixer segment 428 extending oblique to the vertical axis 426. The mixer segment 428 can have an upper end that coincides with the lower end of the drive segment 424. More particularly, the mixer segment 428 can extend from the lower end of the drive segment 424, at an oblique angle to the vertical axis 426, to a lower end near a bottom of the hopper 106. The combined segments of the drive bar 420 can form a bent shape. For example, the drive bar 420 may have a bent L or J shape. Accordingly, an upper end of the drive bar 420 may be centered, e.g., on the vertical axis 426, and a lower end of the drive bar 420 can be off-center, e.g., laterally separated from the vertical axis 426. The drive bar 420 of the support subframe 410 can be rigid. For example, the drive bar 420 may be formed from stainless steel or another rigid material. The non-linear shape of the drive bar 420 can contribute to agitation of the seed as the agitator motor 404 spins the drive bar 420 within the hopper cavity 402.

The crossbar 422, like the drive bar 420, may be segmented for description. In an embodiment, the crossbar 422 includes a first lateral segment 430 extending laterally outward from the drive bar 420 in a first direction 432. For example, the first lateral segment 430 can extend leftward from the vertical drive bar 420, as shown in FIG. 4. The crossbar 422 can include a second lateral segment 436. The second lateral segment 436 may extend from the drive bar 420 in a second direction 438. For example, the second lateral segment 436 can extend rightward from the vertical drive bar 420. The first direction 432 and the second direction 438 may be opposite directions along the same horizontal axis. Alternatively, the first lateral segment 430 and the second lateral segment 436 may extend at oblique angles to each other, however, the segments may nonetheless extend generally opposing directions. The crossbar 422 of the support subframe 410 can be rigid. For example, the crossbar 422 may be include a tube formed from a stiff polymer, such as polyvinyl chloride. In such case, the crossbar 422 may be more flexible than drive bar 420, and less flexible than the one or more agitator members 412 described below. The crossbar 422 can therefore act like a laterally extending paddle to mix and break up seeds surrounding the vertical axis 426.

Rotation of the agitator frame 408 can disrupt and disperse seeds within the hopper cavity 402. A structure of the flexible agitator members 412, which facilitate aggressive but resilient agitation of the seeds, is described further below. Still referring to FIG. 4, however, it will be appreciated that agitation of the seeds can cause the seeds to smoothly flow downward within the hopper cavity 402 toward the seed flow controller 108. The seed flow controller 108 can include several rollers 450. The rollers 450 may be mounted below the hopper 106 to receive the seed as it flows through an outlet of the hopper 106 in the downward direction. Each of the rollers 450 can have a respective outer surface 452. The outer surfaces 452 may be in contact with each other. Seed may be caught at the contact point between the rollers 450 when the rollers spin relative to each other. More particularly, the rollers 450 can grip the seed and pull the seed downward through the contact point to eject the seed. The ejected seed can move toward the spreader 110 (FIG. 3). In an embodiment, the spreader 110 includes a spinning disk. When the seed lands on the spinning disk, it can be ejected laterally outward from the seed spreading assembly 104 to the target geography.

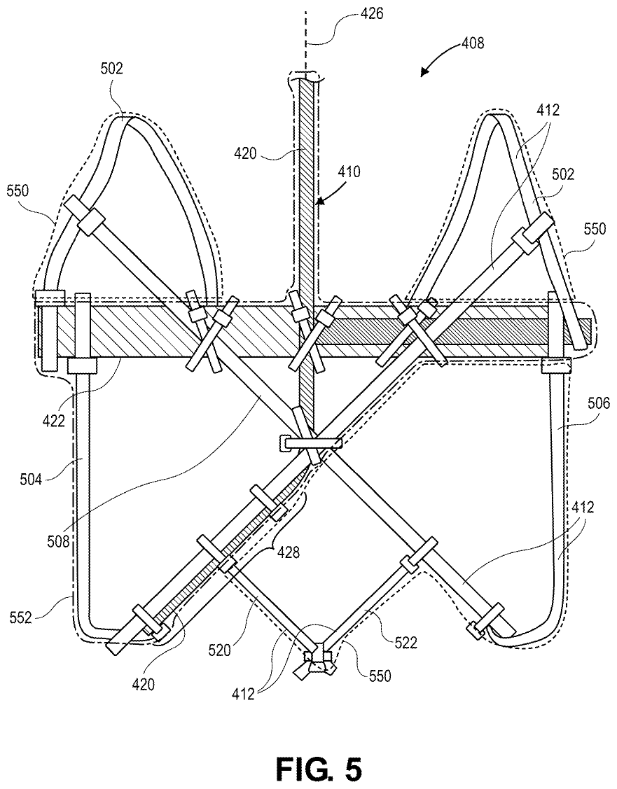

Referring to FIG. 5, a front view of an agitator is shown in accordance with an embodiment. The agitator frame 408 includes one or more agitator members 412 (shown without cross-hatching) that are relatively flexible, compared to the agitator subframe 410 (shown with cross-hatching). The comparative flexibility allows the members to engage and dislodge seed resiliently. In an embodiment, the agitator members 412 including agitator loop 502 extending vertically upward from the support subframe 410. For example, the agitator loop 502 can extend vertically upward from the crossbar 422 on a first lateral side of the drive bar 420. The agitator loop 502 can extend from a first end at a first location on the crossbar 422, to a second and at a second location on the crossbar 422. The first location and the second location can be horizontally spaced from each other. Accordingly, the agitator loop 502 can extend upward from the first location, curve radially outward, and loop back downward to the second location on the crossbar 422. The loop structure can form a flexible scoop that can act to scrape and loosen seed in an upper region of the hopper cavity 402 as the support subframe 410 rotates about the vertical axis 426. The scraping action can cause seed lodged in the upper region to fall downward toward the lower section of the agitator frame 408.

The agitator frame 408 may include several agitator loops 502. In an embodiment, a second agitator loop 502 is connected to the crossbar 422 on an opposite side of the drive bar 420 from the first agitator loop 502. The agitator loops 502 can flank the drive bar 420. For example, the vertical columns 416 and the bearing 414 (FIG. 4) may be located above the crossbar 422, between the agitator loops 502, such that the agitator loops 502 sweep the section of the hopper cavity 402 that is radially outward of the vertical columns 416. More particularly, as the drive bar 420 rotates on the vertical axis 426, the agitator loops 502 can sweep an annular space between the vertical axis 426 and the hopper wall 406.

The agitator loops 502 may be flexible enough to give under a more rigid and/or dense structure. For example, the agitator loop 502 may flex out of the way of a large piece of bark or a very dense seed clump within the hopper cavity 402. Resiliently flexing out of the way may avoid overloading the agitator frame 408. More particularly, the agitator frame 408 may resiliently flex rather than fail stiffly. Repeated whipping of the rigid seed structure by the agitator loops 502, however, may eventually break up the seed clump and/or seed bridging to allow the seed to be smoothly ejected and dispensed to the target geography. Accordingly, the hybrid flexibility of the agitator frame 408 can facilitate seed spreading with a reduced likelihood of mechanical failure from problem materials.

The one or more agitator members 412 can include a side link 504 extending vertically between two locations on the support subframe 410. For example, the side link 504 can extend upward from the drive bar 420 of the support subframe 410 to the crossbar 422 of the support subframe 410. Given that the drive bar 420 and the crossbar 422 may be relatively rigid, the side link 504 may be rigidly constrained by the components. More particularly, seeds acting on the side link 504, which may be formed from a more flexible material than the drive bar 420 or the crossbar 422, may minimally deflect the side link 504. Rather, the side link 504 may be rigidly stabilized by the support subframe 410. The structural region formed by the crossbar 422, the drive bar 420, and the side link 504, may therefore be a rigid region that resiliently flexes to a lesser degree than the agitator loop 502.

In an embodiment, the one or more agitator members 412 include a second side link 506. The second side link 506 can be on an opposite side of the vertical axis 426 from the side link 504. Like the side link 504, however, the second side link 506 may extend vertically downward from the crossbar 422 at a location that is on an opposite side of the drive bar 420 from the attachment point of the side link 504. The second side link 506 may extend from the support subframe 410 to a slant member 508. More particularly, the one or more agitator members 412 can include a slant member 508 extending from the crossbar 422 in a slanted direction downward to a lower end of the second side link 506. The slant member 508 and the second side link 506 can therefore be connected to each other below the crossbar 422.

The second side link 506 may be contrasted with the side link 504 based on the structural region that it defines along with the slant member 508 and the crossbar 422. Whereas the structural region defined by the side link 504, the crossbar 422, and the drive bar 420 is relatively rigid, as described above, the structural region defined by the second side link 506, the slant member 508, and the crossbar 422, may be relatively flexible. The slant member 508 may be formed from a material and/or have dimensions that cause it to be more flexible than the mixer segment 428 of the drive bar 420. Similarly, the second side link 506 may be formed from a material and/or have dimensions that cause it to be more flexible than the slant member 508. Accordingly, in combination, the second side link 506 and the slant member 508 are more flexible than the combination of the side link 504 and the mixer segment 428. The relative flexibility allows the structural region having the second side link 506 (the right side region in FIG. 5) to resiliently deflect more than the structural region having the side link 504 (the left side region in FIG. 5). The left side region may not flex easily, and can push seed as the structure rotates, while the right side region can deflect to give way to seed clumps. The combined rigid and flexible sides (rigidity gauged relative to each other) can therefore disrupt seed without overloading and breaking the agitator frame 408.

The rigid and flexible sides of the agitator frame 408 below the crossbar 422 can disrupt and move seed downward within the hopper cavity 402. To guide the seed toward the rollers 450, the one or more agitator members 412 may include one or more center legs vertically above the rollers 450. More particularly, the agitator members 412 can include a first center leg 520 and a second center leg 522. The first center leg 520 can be coupled to the second center leg 522 above the rollers 450. For example, the first center leg 520 may extend vertically downward from the support subframe 410, e.g., the mixer segment 428, and the second center leg 522 can extend vertically downward from the slant member 508. The center legs may be coupled to each other at a location below the slant member 508 and the support subframe 410. The connection point may be on or near the vertical axis 426. The center legs may be formed from a flexible material. The center legs may therefore whip through the seed and act as guides for the disrupted seed to follow downward toward a central location along the vertical axis 426. The center legs can feed the seeds into the roller 450. The rollers can therefore effectively grab onto the seeds and pull the seeds from the hopper to be dispensed. The center legs may also exert a disruptive load to the seeds that can break up the seeds and allow the rollers 450 to take the seeds more freely when the rollers 450 become unclogged. Accordingly, the center legs can disperse and guide seeds downward to be ejected and spread onto the target geography.

A relative flexibility of the individual agitator members 412 can be defined. More particularly, a stiffness of each member may be predetermined based on a material and/or dimensional makeup of the member. By way of example, each of the agitator members 412 may be formed from a zip tie. The zip ties can have respective material and/or sizes that contribute to the stiffness of the member. In an embodiment, one or more of the agitator loops 502, the slant member 508, and/or one or more of the centering legs 520, 522 may have a same flexibility. For example, each of the members may be formed from a same type of zip tie. By contrast, the side link 504 and/or the second side link 506 may be more flexible than the agitator loop 502, the slant member 508, or the centering legs 520, 522. For example, each of the side links 504, 506 may include a same type of zip tie that is formed from a more flexible material or has smaller cross-sectional dimensions than the type of zip tied used for the, e.g., agitator loop 502. Therefore, the structural region having the second side link 506 may be more flexible and may deflect more under a load than other structural regions of the agitator frame 408.

Structural regions of relative flexibility are further defined with reference to the dash-dash and dash-dot lines in FIG. 5. More particularly, dash-dash lines denote a plurality of flexible regions 550. Similarly, dash-dot lines denote rigid region 552. As described above, the flexible region(s) 550 can include the regions between the agitator loops 502 and the crossbar 422. Furthermore, the flexible region(s) 550 can include the region between the rigid drive bar 420 and crossbar 422 to the outer perimeter along the second side link 506 and the center legs 520, 522, e.g., the rightward section of the structural frame shown in FIG. 5. The rigid region 552 can include regions not within the flexible region(s) 520. For example, the dash-dot lines encompass the rigid structures of the drive bar 420 and the crossbar 422. Furthermore, the rigid region 552 can include the regions between the drive bar 420 and the crossbar 422, e.g., the leftward section of the structural frame shown in FIG. 5. Therefore, the combined rigidity and/or flexibility of the frame members can form regions of relative rigidity and/or relative flexibility that push rigidly through seeds and/or flex resiliently under the resistance of such seeds. The combined rigidity/flexibility of the frame facilitates effective agitation and dispersal of the seeds.

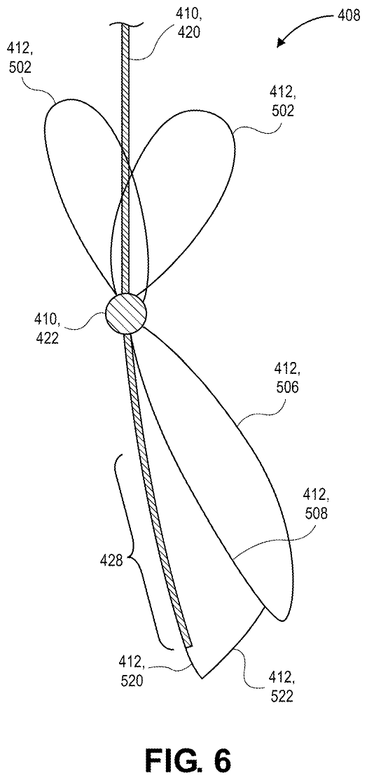

Referring to FIG. 6, a side view of an agitator is shown in accordance with an embodiment. The relative flexibilities of the agitator members 412 can cause the agitator frame 408 to resiliently flex when the drive bar 420 is rotated through the seed in the hopper cavity 402. The agitator loop 502 structures can cantilever upward from the crossbar 422 such that seed within the hopper 106 can resist the loops to cause the loops to resiliently flex. The agitator loops 502 are shown flexing and deflecting in opposite directions because the drive bar 420 is being rotated through the seed. As the agitator loops are dragged through the seed, the agitator loops can break apart seed bridges to force the seeds downward within the hopper 106.

Below the crossbar 422, the more rigid side region having the side link 504 is illustrated in line with the mixer segment 428 of the drive bar 420. The rigid region flexes only slightly and can therefore generate great force within the seeds to cause the seeds to disperse. By contrast, the more flexible side region having the second side link 506 attached to the slant member 508 can resiliently deflect under loading by the seeds. The flexible side can push the seeds, however, when a large seed clump is encountered, the side can flex to avoid overloading the agitator frame 408. Furthermore, the flexible region can slide the seeds within the hopper 106 until a line of contact between the rollers 450 is directly below the seed clump. When the seed clump aligns with the rollers 450, the rollers 450 can grip the seed clump and pull it downward away from the flexible region. Seed flow can therefore be facilitated by the resilience of the flexible region, in combination with the aggressive disruption provided by the more rigid region.

As described above, the centering legs 520, 522 can agitate the seeds in the bottom of the hopper 106. The center legs 520, 522 may guide the seeds to fall downward into the roller 450. The V-shaped structural region formed by the center legs can rotate within the bottom zone of the hopper 106 to disperse the seeds for smooth ejection through the rollers 450 to the spreader 110. Accordingly, the hybrid flexibility of the agitator frame 408 can move seeds through the hopper 106 with a reduced likelihood of binding or overloading the agitator 210. Seeds may therefore be efficiently dispensed onto the target geography.

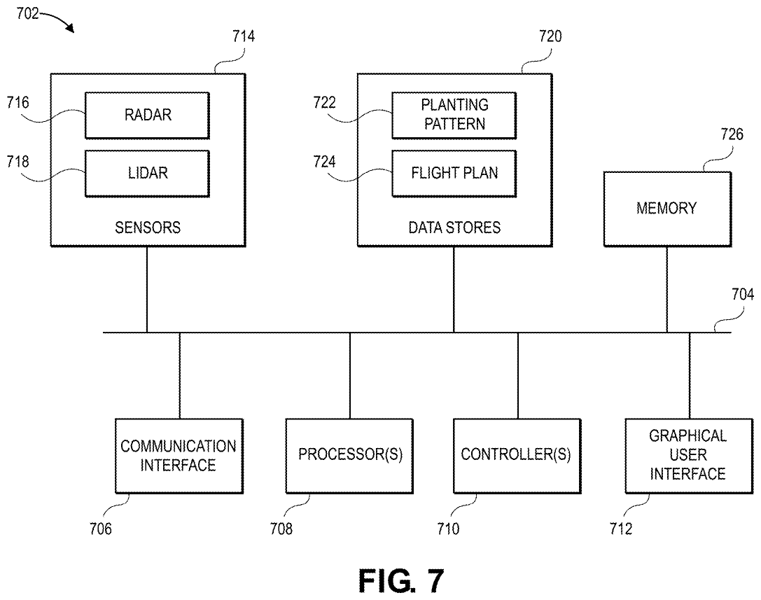

Referring to FIG. 7, a block diagram of a computer system is shown in accordance with an embodiment. A computer system 702 can include the planting control system 208 to implement the agitation, conveyance, and spreading functions described above. More particularly, the computer system 702 can perform computer implemented methods that control the agitation, conveyance, and spreading functions. In an embodiment, one or more processors 708 of the computer system 702 can execute instructions stored on a non-transitory computer readable medium to cause the planting system 100 to perform the agitation, conveyance, and spreading functions.

The computer system 702 can include hardware elements connected via a bus 704, including a network interface 706, that enables the computer system 702 to connect to other computer systems over a local area network (LAN), wide area network (WAN), mobile network (e.g., EDGE, 3G, 4G, or other mobile network), or other network. The network interface 706 can further include a wired or wireless interface for connecting to infrared, Bluetooth, or other wireless devices, such as other mobile transport platforms. The computer system 702 can include the one or more processors 708, such as a central processing unit (CPU), field programmable gate array (FPGA), application-specific integrated circuit (ASIC), network processor, or other processor. Processors 708 may include single or multi-core processors.

In some embodiments one or more controllers 710 can be used to control the navigation of the mobile transport platform. The controllers 710 may include hardware and software controllers 710 designed to control the various mobile transport platforms described herein. In some embodiments, the computer system 702 can include a graphical user interface (GUI) 712. The GUI 712 can connect to a display (LED, LCD, tablet, touchscreen, or other display) to output user viewable data. In some embodiments, the GUI 712 can be configured to receive instructions, e.g., through a touchscreen or other interactive interface.

In some embodiments one or more sensors 714 can be used to navigate and to gather data describing the surrounding area that can be used to create a map of local land characteristics. In some embodiments, the sensor 714 can include various electromagnetic sensors such as visual, multispectral, hyperspectral, RADAR 716, LiDAR 718, and infrared sensors. In some embodiments, the sensors 714 can include various communication modules such as GPS or other positioning modules and mobile network communication modules.

In some embodiments, the computer system 702 may include local or remote data stores 720. Data stores 720 can include various computer readable storage media, storage systems, and storage services, such as disk drives, CD-ROM, digital versatile disc (DVD), or other optical storage, magnetic cassettes, magnetic tape, magnetic disk storage or other magnetic storage devices, relational databases, object storage systems, local or cloud-based storage services, or any other storage medium, system, or service. The data stores 720 can include data generated, stored, or otherwise utilized as described herein. For example, the data stores 720 can include all or portions of a planting pattern 722 or a flight plan 724, generated and stored for reference to navigate the planting system 100 to the target geography. Memory 726 can include various memory technologies, including RAM, ROM, EEPROM, flash memory or other memory technology. Memory 726 can include executable code to implement methods as described herein.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A planting system comprising:
an unmanned aerial vehicle (UAV); and
a seed spreading assembly mounted on to the UAV, wherein the seed spreading assembly includes
a hopper having a hopper cavity, and
an agitator coupled to the hopper, wherein the agitator includes an agitator frame in the hopper cavity, wherein the agitator frame includes one or more agitator members coupled to a support subframe, and wherein the one or more agitator members are more flexible than the support subframe.

2. The planting system of claim 1, wherein the support subframe includes a drive bar extending vertically within the hopper cavity, and a crossbar coupled to the drive bar and extending horizontally within the hopper cavity.

3. The planting system of claim 2, wherein the drive bar includes a drive segment extending along a vertical axis within the hopper cavity, and a mixer segment extending oblique to the vertical axis.

4. The planting system of claim 2, wherein the crossbar includes a first lateral segment extending from the drive bar in a first direction, and a second lateral segment extending from the drive bar in a second direction.

5. The planting system of claim 1, wherein the one or more agitator members include an agitator loop extending vertically upward from the support subframe.

6. The planting system of claim 1, wherein the one or more agitator members include a side link extending from a drive bar of the support subframe to a crossbar of the support subframe.

7. The planting system of claim 1, wherein the one or more agitator members include a slant member and a side link, wherein the side link extends from the support subframe to the slant member, and wherein the side link is more flexible than the slant member.

8. The planting system of claim 1, wherein the one or more agitator members include a slant member, a first center leg, and a second center leg, wherein the first center leg extends vertically downward from the support subframe, wherein the second center leg extends vertically downward from the slant member, and wherein the first center leg is coupled to the second center leg below the slant member and the support subframe.

9. The planting system of claim 1, wherein the agitator includes an agitator motor operably coupled to the support subframe.

10. The planting system of claim 1, wherein the seed spreading assembly includes a plurality of rollers mounted below the hopper, and wherein the plurality of rollers have respective outer surfaces in contact with each other.

11. A seed spreading assembly comprising:
a hopper having a hopper cavity; and
an agitator coupled to the hopper, wherein the agitator includes an agitator frame in the hopper cavity, wherein the agitator frame includes one or more agitator members coupled to a support subframe, and wherein the one or more agitator members are more flexible than the support subframe.

12. The seed spreading assembly of claim 11, wherein the support subframe includes a drive bar extending vertically within the hopper cavity, and a crossbar coupled to the drive bar and extending horizontally within the hopper cavity.

13. The seed spreading assembly of claim 11, wherein the one or more agitator members include an agitator loop extending vertically upward from the support subframe.

14. The seed spreading assembly of claim 11, wherein the one or more agitator members include a side link extending from a drive bar of the support subframe to a crossbar of the support subframe.

15. The seed spreading assembly of claim 11, wherein the one or more agitator members include a slant member and a side link, wherein the side link extends from the support subframe to the slant member, and wherein the side link is more flexible than the slant member.

16. An agitator frame for a planting system comprising:
a support subframe; and
one or more agitator members coupled to the support subframe, wherein the one or more agitator members are more flexible than the support subframe.

17. The agitator frame of claim 16, wherein the support subframe includes a drive bar extending vertically, and a crossbar coupled to the drive bar and extending horizontally.

18. The agitator frame of claim 16, wherein the one or more agitator members include an agitator loop extending vertically upward from the support subframe.

19. The agitator frame of claim 16, wherein the one or more agitator members include a side link extending from a drive bar of the support subframe to a crossbar of the support subframe.

20. The agitator frame of claim 16, wherein the one or more agitator members include a slant member and a side link, wherein the side link extends from the support subframe to the slant member, and wherein the side link is more flexible than the slant member.
